(19) United States
(12) Patent Application Publication
(10) Pub. No.: US 2013/0058096 A1
(43) Pub. Date: Mar. 7, 2013

(54) OPTICAL LOW INDEX ALUMINA FILM FOR LIGHTING APPLICATIONS

(71) Applicants: Peter W. BROWN, Twinsburg, OH (US); Wayne Allen BROWN, Mayfield Heights, OH (US); Jiawei LI, Avon Lake, OH (US); Tianji ZHAO, Highland Heights, OH (US)

(72) Inventors: Peter W. BROWN, Twinsburg, OH (US); Wayne Allen BROWN, Mayfield Heights, OH (US); Jiawei LI, Avon Lake, OH (US); Tianji ZHAO, Highland Heights, OH (US)

(21) Appl. No.: 13/223,345

(22) Filed: Sep. 1, 2011

(51) Int. Cl. F21V 9/04; G02B 5/28; B05D 5/06; G02B 1/10

(52) U.S. Cl. 362/293; 359/588; 359/359; 427/162

(57) ABSTRACT

Optical interference multilayer coatings of alternating first layers and second layers are provided. The first layers comprise alumina and have a refractive index that is about 1.38 to about 1.55 at 550 nm, while the second layers having a higher refractive index than the first layers. The first layers may be formed via chemical vapor deposition from an alumina precursor. Lamps comprising a light source and a light-transmissive envelope having a surface and at least partially enclosing the light source are also provided. At least a portion of the surface of the light-transmissive envelope is provided with an optical interference multilayer coating. Methods of forming an optical interference multilayer coating are also provided via chemical vapor deposition from an alumina precursor.

### FIELD OF THE INVENTION

The present invention generally relates to optical multilayer coatings having low refractive index layers. In particular, some embodiments herein relate to optical multilayer coatings having low refractive index layers comprising alumina deposited by an effective process.

### BACKGROUND

Optical interference coatings, sometimes also referred to as thin film optical coatings or filters, comprise alternating layers of two or more materials of different indices of refraction. Some such coatings or films have been used to selectively reflect or transmit light radiation from various portions of the electromagnetic radiation spectrum, such as ultraviolet, visible and infrared radiation. For instance, optical interference coatings are commonly used in the lamp industry to coat reflectors and lamp envelopes. One application in which optical interference coatings are useful is to improve the illumination efficiency, or efficacy, of lamps by reflecting infrared energy emitted by a filament, or arc, toward the filament or arc while transmitting visible light of the electromagnetic spectrum emitted by the light source. This decreases the amount of electrical energy necessary for the light source to maintain its operating temperature.

Optical interference coatings generally comprise two different types of alternating layers, one having a low refractive index and the other having a high refractive index. With these two materials having different indices of refraction, a multilayer optical interference coating, which can be deposited on the surface of the lamp envelope, can be designed. In some cases, the coating or filter transmits the light in the visible spectrum region (generally from about 380 to about 780 nm wavelength) emitted from the light source while it reflects the infrared light (generally from about 780 to about 2500 nm). The returned infrared light heats the light source during lamp operation and, as a result, the lumen output of a coated lamp is considerably greater than the lumen output of an uncoated lamp.

Many known low refractive index materials, when used as components of optical interference coatings, cannot preserve their optical and mechanical integrities at lamp operating temperatures. The problems are often manifested as loss of visible light transmission, degradations in reflectance of IR radiation (where such reflectance is desired), and/or coating failures in the forms of excessive cracking and delamination. However, in order to achieve high energy efficiencies, these varying degrees of degradation in optical and mechanical integrities cannot be tolerated.

Silicon dioxide (SiO₂) is known as a low refractive index layer for operation at relatively high operation temperatures. However, the use of silicon dioxide as a low refractive index layer on a lamp can have several disadvantages. For example, layers of silicon dioxide can contain impurities (e.g., water and/or hydrocarbons), which may lead to absorbance around 3.6 microns wavelength. Additionally, layers of silicon dioxide have a smaller thermal expansion coefficient than several materials suitable for use in a high index layer (e.g., tantalum pentoxide and/or niobium pentoxide), which can lead to delamination of the layers at elevated temperatures, particularly when the total film stack thickness exceeds about 4 microns (μm).

Accordingly, there remains a need for optical interference multilayer coatings having enhanced optical and mechanical integrities, e.g., at high temperatures such about 400° C., or up to about 1000° C.

### BRIEF DESCRIPTION

Aspects and advantages of the invention will be set forth in part in the following description, or may be obvious from the description, or may be learned through practice of the invention.

One embodiment of the present invention is generally directed to an optical interference multilayer coating comprising a plurality of alternating first layers and second layers. The first layers generally have a refractive index that is about 1.38 to about 1.55 at 550 nm (e.g., about 1.45 to about 1.55 at 550 nm), while the second layers having a higher refractive index than the first layers (e.g., the second layers can have a refractive index of from about 1.7 to about 2.8 at 550 nm). The first layers comprise alumina. For example, the first layers may be chemical vapor deposited, e.g., formed via chemical vapor deposition from an alumina precursor.

A further embodiment of the present invention is directed to a lamp comprising a light source and a light-transmissive envelope having a surface and at least partially enclosing the light source. At least a portion of the surface of the light-transmissive envelope is provided with an optical interference multilayer coating comprising a plurality of alternating first layers and second layers. The first layers generally have a refractive index that is about 1.38 to about 1.55 at 550 nm (e.g., about 1.45 to about 1.55 at 550 nm), while the second layers having a higher refractive index than the first layers (e.g., the second layers can have a refractive index of from about 1.7 to about 2.8 at 550 nm). The first layers comprise alumina. For example, the first layers may be chemical vapor deposited, e.g., formed via chemical vapor deposition from an alumina precursor.

A further embodiment of the present invention is directed to a method of forming an optical interference multilayer coating. The method can comprise forming a first layer on a substrate via chemical vapor deposition from an alumina precursor (e.g., di-isopropoxy-acac-aluminum; trimethylaluminum; aluminum-di-acetoacetic ester chelate; Al₂(C₅H₇O₂)₃; aluminum tri-isopropoxide, a mixture of SiCl₄, AlCl₃, CO₂, and H₂; other aluminum alkoxides; or mixtures thereof); forming a second layer on the first layer; and annealing the first and second layers such that the first layer has a refractive index that is about 1.38 to about 1.55 at 550 nm, and the second layer has a higher refractive index than the first layer.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a schematic depiction of an exemplary lamp, in accordance with embodiments of the invention;

FIG. 2 is a graph depicting the refractive index as a function of wavelength (in Angstrom) for individual films of ZrO₂, Ta₂O₅, SiO₂, Nb₂O₅, HfO₂, optical alumina, and common alumina, as further discussed in the Examples;

FIG. 3 is a graph depicting the absorption as a function of wavelength (in Angstrom) for a film of optical alumina as deposited and after annealing, as further discussed in the Examples; and

FIG. 4 is a graph depicting the refractive index as a function of wavelength for a film of optical alumina as deposited and after annealing, as further discussed in the Examples.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, an embodiment of the invention is directed to an optical interference multilayer coating comprising a plurality of alternating first and second layers. The first layers have relatively low refractive index, and the second layers have relative high refractive index (e.g., higher than the refractive index of the first layers).

According to particular embodiments of the invention, the first layers having relatively low refractive index comprise alumina (also known as “aluminum oxide”). Alumina can generally be represented by the chemical formula Al₂O₃. The first layer comprising alumina can generally be transparent without absorption in the visible spectrum. Such low refractive index layers of alumina may be referred to as “optical alumina” layers herein.

According to embodiments of the invention, the first layers, which include alumina, may be referred to as the “low index” layers, and may have a refractive index of from about 1.38 to about 1.55 at 550 nm. For example, the first layers may have a refractive index of from about 1.45 to about 1.55 at 550 nm.

In one particular embodiment, the alumina has a refractive index that is about 1.38 to about 1.55 at 550 nm when deposited as a thin film (e.g., from about 1.45 to about 1.55 at 550 nm). That is, the alumina material itself can provide the first layer with its refractive index property, even if it contains other materials (e.g., dopants, etc.). For example, the first layer can be, in certain embodiments, at least 90% by weight alumina, such as at least 95% by weight. In particular embodiments, the first layer can be at least 99% by weight alumina.

Without wishing to be bound by any particular theory, it is believed that such relatively low refractive index films of alumina may be achieved via a chemical vapor deposition process utilizing particular alumina precursors, including but not limited to, di-isopropoxy-acac-aluminum; trimethylaluminum; aluminum-di-acetoacetic ester chelate; Al₂(C₅H₂O₂)₃; aluminum tri-isopropoxide, a mixture of SiCl₄, AlCl₃, CO₂, and H₂; aluminum alkoxides; or mixtures thereof. In one particular embodiment, for example, the alumina precursor can be di-isopropoxy-acac-aluminum.

In general, the second layers may be referred to as the “high index” materials, and may have a refractive index of from about 1.7 to about 2.8 at 550 nm. Typically, such high index materials may comprise any material having a refractive index relatively higher than that of the first layers. Many refractory materials are suitable for high index materials. Such high index materials may be independently selected from one or more oxides (or mixed oxides) of one or more metal selected from the group consisting of Ti, Zr, Hf, Nb, W, Mo, In, and Ta; or the like. The composition of the second layers may include (for example): (1) physical mixtures of two or more of such metal oxides; or (2) may include physical mixtures of a mixed metal oxide and another metal oxide; or (3) may include a mixed metal oxide of at least two metals in the group; among other possibilities. Specific possible examples may include NbTaX oxide where X is selected from the group consisting of Hf, Al and Zr; or NbTiY oxide where Y is selected from the group consisting of Ta, Hf, Al and Zr; or TiAlZ oxide where Z is selected from the group consisting of Ta, Hf and Zr. In general, then, the second layers may comprise any material heretofore typically employed as a high refractive index material in optical interference multilayer coatings, as well as other high refractive index materials.

It is typical, although not always necessary, that the first and second layers are both alternating and adjacent. In accordance with embodiments, the article may further comprise at least one substrate. In some embodiments, the first layer is closer to the at least one substrate than the second layer. In some other embodiments, the second layer is closer to the at least one substrate than the first layer.

According to embodiments of the invention, the optical interference multilayer coating may comprise any arbitrary total number of layers (high and low index) above two. The total number of layers is not particularly critical. More particularly, the total number of layers may range from any integer from 4 to 250 inclusive, and stated more narrowly, from about 30 to about 150 layers. Typically, the alternating first and second layers in the plurality of layers may be spectrally adjacent to at least each other, and may also be physically adjacent to each other.

According to embodiments of the invention, the optical interference multilayer coating may have a total geometrical thickness that varies in a wide range. It may be up to about 25 microns, or may be as low as about 0.001 microns. For example, and not by way of limitation, the total geometrical thickness may be in a range of from about 1 to about 15 microns. Stated more narrowly, the optical interference multilayer coating may also have a total geometrical thickness of from about 10 to about 15 microns. The individual low and high refractive index layers (i.e., first and second layers) may typically have a thickness of from about 20 nm to about 500 nm, or sometimes from about 10 nm to about 200 nm.

The multilayer coatings according to embodiments of the invention may be deposited by any suitable deposition technique known for depositing coating materials. Exemplary techniques may include, but are not limited to: chemical vapor deposition (e.g., low pressure CVD, LPCVD) and plasma-assisted chemical vapor deposition; and physical vapor deposition methods such as thermal evaporation, electron beam evaporation, ion plating, dip coating, ion beam deposition, sputtering, spray coating, or laser ablation; or the like.

In accordance with one embodiment, the first and/or second layers may be formed by a chemical vapor deposition process (CVD), such as atmospheric pressure CVD; low-pressure CVD; high-vacuum CVD; ultrahigh-vacuum CVD; aerosol-assisted CVD; direct liquid-injection CVD; microwave plasma-assisted CVD; plasma-enhanced CVD; remote plasma-enhanced CVD; atomic layer CVD; hot wire CVD; metal-organic CVD; hybrid physical-chemical vapor deposition; rapid thermal CVD; vapor phase epitaxy; etc.; or combinations thereof.

As is generally understood, in a typical chemical vapor deposition process, a substrate is exposed to one or more volatile or gas-like precursors (usually molecular precursors), which precursors react and/or decompose on the substrate surface to produce the desired deposit. There are a variety of different types of CVD processes, which may be classified by the features of their operating pressure, characteristics of the vapor, types of energy input, or other features. All of the following are to be included within the scope of “CVD” processes, as that term is used herein. For instance, some CVD processes include: atmospheric pressure CVD; low-pressure CVD (LPCVD) (wherein chemical vapor deposition typically occurs at sub-atmospheric pressures); and high- or ultrahigh-vacuum CVD, which is usually conducted at below about 10⁻⁶ Pa. In other forms of CVD, the precursor is not strictly in the gaseous state: aerosol-assisted CVD employs precursors as a liquid-gas aerosol, while direct liquid-injection CVD (DLICVD) uses liqueform precursors which are injected and transported to a substrate.

Some CVD methods are assisted by energetic means, such as microwave plasma-assisted CVD (MPCVD), plasma-enhanced (or plasma-assisted) CVD (PECVD), and remote plasma-enhanced CVD (RPECVD). Other types of CVD may include atomic layer CVD (ALCVD), hot wire CVD (HWCVD), metal-organic CVD (MOCVD); hybrid physical-chemical vapor deposition (HPCVD), rapid thermal CVD (RTCVD), vapor phase epitaxy (VPE); and the like. These respective types of CVD are not always intended to be mutually exclusive; therefore, combinations employing more than one of the foregoing CVD processes are also contemplated. For example, any person skilled in the field would clearly understand that plasma-assisted CVD may be inclusive of remote plasma-enhanced CVD. Similarly, a hot wire CVD process employing organometallic precursors can also be considered an MOCVD process, as would be readily understood by those skilled in the art.

Where LPCVD is used to deposit multilayer coatings, it may typically employ the process as set forth in U.S. Pat. No. 5,143,445, pertinent teachings of which are hereby incorporated by reference. For example, an LPCVD process can be utilized at temperatures of about 600° C. or less and pressures of about 10 torr or less to deposit and form the first layer comprising alumina (e.g., utilizing an alumina precursor as discussed above). As stated, the first layer comprising alumina can generally be transparent without absorption in the visible spectrum. The first layer comprising alumina can have very low absorption in the visible spectrum as deposited, and can be annealed to have no significant absorption in the visible spectrum. Annealing can be achieved, in certain embodiments, via heating to anneal temperatures of from about 400° C. to about 800° C. (e.g., about 600° C. to about 800° C.).

In accordance with other embodiments, the first and/or second layers may be formed by a physical vapor deposition process (PVD). As would be generally understood by persons skilled in the art, in a typical physical vapor deposition (PVD) process, a material is vaporized by a physical process and thereafter condensed at a substrate to form a deposit. Sometimes, the vaporized material can undergo a reaction such as oxidation (by reaction with oxygen). Often, a deposit is made on a substrate by the steps of converting the material to be deposited into vapor by a physical means, transporting the vapor from its source to the substrate, and condensing the vapor on the substrate. Generally, in PVD processes, the vaporized material (usually in atomic form, such as metal atoms) does not itself have to undergo decomposition in order to be deposited. This is the typical distinguishing factor from CVD, where a precursor (usually molecular) must decompose or react before forming a deposit. PVD processes are often characterized by the type of energetic input needed to form the vapor. As used herein, PVD processes may include thermal evaporation, RF evaporation, electron beam evaporation, reactive evaporation, DC sputtering, RF sputtering, microwave sputtering, magnetron sputtering, microwave-enhanced DC magnetron sputtering, arc plasma deposition, reactive sputtering, laser ablation; and the like.

These respective types of PVD are not always intended to be mutually exclusive; therefore, combinations employing more than one of the foregoing PVD processes are also contemplated. For example, it would be understood that “magnetron sputtering” may be inclusive of both DC and RF magnetron sputtering. Similarly, it would be understood that “DC magnetron sputtering” may be inclusive of “microwave-enhanced DC magnetron sputtering”. However, regardless of whether alternative methods with overlapping scope is recited, any person skilled in the field would clearly understand the nature of the method.

Where RF magnetron sputtering is used to deposit multilayer coatings, one may suitably employ processes shown in U.S. Pat. No. 6,494,997, hereby incorporated by reference in pertinent part. Magnetron sputtering is where a high-energy inert gas plasma is used to bombard a target. The sputtered atoms condense on the cold glass or quartz housing. DC (direct current), pulsed DC (40-400 KHz), or RF (radio frequency, 13.65 MHz) processes may be used.

Coatings according to embodiments of the invention can be utilized for any of a wide variety of applications where optical interference coatings are desired or typically used. These include, for example, lighting applications (e.g., lamps), optical waveguides, reflectors, decorative materials, security printing; or the like. In some embodiments the coatings are used to selectively reflect one portion of the electromagnetic spectrum while transmitting another portion of the electromagnetic spectrum. For instance, the coatings can be used as a “cold mirror” or a “hot mirror”. A “cold mirror” is an optical filter that reflects visible light while at the same time permitting longer wavelength infrared energy to pass through the filter. A “hot mirror” is an optical filter that reflects infrared radiation while at the same time permitting shorter wavelength visible light to pass through the filter. One nonlimiting application of hot mirrors herein is to return infrared radiation to the filament of a lamp in order to increase lamp efficiency.

In accordance with certain embodiments, the optical interference multilayer acts as a “hot mirror”, i.e., it transmits light in the visible spectrum region (generally from about 380 to about 780 nm wavelength) emitted from a light source while it reflects infrared light (generally from about 780 to about 2500 nm). In such embodiments, the optical interference multilayer coating may have an average transmittance in visible light of greater than 60% (more preferably, greater than about 80%) and have an average reflectance of at least about 30% (and more usually, greater than about 70%) in the infrared region of the electromagnetic spectrum.

By use of the alumina materials disclosed herein for the low index layer of optical interference coatings, one can obtain a material which can resist frequent temperature changes, especially changes which include increases to 800° C. or higher. One manifestation of such high temperature resistance is that coatings according to embodiments of the present invention often do not suffer from excessive delamination or cracking. For instance the optical interference multilayer coating is typically capable of repeated cycling between room temperature and greater than or equal to about 800° C. (e.g., from 200° C. to 1000° C.) without significant mechanical degradation of the first (low index) layers; or of the second layers; or both.

Another manifestation of enhanced temperature resistance is that coatings according to embodiments of the present invention often do not suffer from excessive light scattering in the visible region.

In accordance with embodiments of the invention, there are also provided a lamp or lamps including the optical interference multilayer coatings of the present disclosure. Such lamps generally comprise a light-transmissive envelope having a surface, and a light source, with the envelope at least partially enclosing the light source. At least a portion of the surface of the light-transmissive envelope is provided with the optical interference multilayer coating. As is generally known, such light-transmissive envelopes may be composed of any material which is light transmissive to an appreciable extent and is capable of withstanding relatively hot temperature (e.g., about 800° C. or even above); for example, it may be composed of quartz, ceramic, or glass; or the like. The light source may be an incandescent source (for example, one which provides light through resistive heating of a filament); and/or it may be an electric arc discharge source, such as a high-intensity discharge (HID) source.

Usually, where a filament is employed, it is composed of a refractory metal, generally in coiled form, such as tungsten or the like, as is well known. To energize the lamp, there is typically provided at least one electric element arranged in the envelope and connected to current supply conductors (or electrical leads) extending into the envelope. Usually, the envelope encloses a fill gas, especially, an ionizable fill gas, which may comprise at least one rare gas (such as krypton or xenon), and/or a vaporizable halogen substance, such as an alkyl halide compound (e.g., methyl bromide). Other fill compositions are also contemplated, such as metal halides, mercury, and combinations thereof.

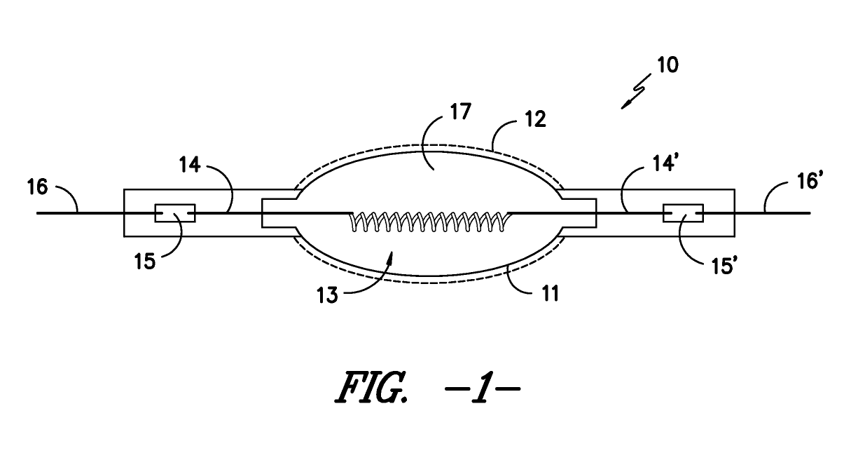

Referring now to FIG. 1, here is shown a schematic depiction of an exemplary lamp in accordance with embodiments of the invention. It is not intended to be limiting, and is not a scale drawing. In this illustrative embodiment, lamp 10 comprises a hermetically sealed, vitreous, light transmissive quartz envelope 11, the outer surface of which is coated with a multilayer optical interference coating 12, such as the multilayer optical inference coatings discussed above. Envelope 11 encloses coiled tungsten filament 13 which can be energized by inner electrical leads 14,14′. The inner electrical leads 14,14′ are welded to foils 15,15′, and outer electrical leads 16,16′ are welded to the opposite ends of the foils. In the interior 17 of envelope 11 is disposed an ionizable fill comprising a halogen or halogen compound.

In one embodiment, the multilayer optical interference coating 12 can be configured to transmit the light in the visible spectrum region (generally from about 380 to about 780 nm wavelength) emitted from the filament 13 while it reflects the infrared light (generally from about 780 to about 2500 nm).

In order to promote a further understanding of the invention, the following examples are provided. These examples are illustrative, and should not be construed to be any sort of limitation on the scope of the claimed invention.

### EXAMPLES

Prior alumina films have been generally deposited in sapphire form and have a refractive index of 1.85-1.9 at 550 nm, which is too high to be considered for use as a low refractive index layer. Surprisingly, however, it has been found that a new “optical alumina” film can be made to have a refractive index of about 1.38-1.55, e.g., from about 1.45-1.50. This optical alumina film has been evidenced by observations of CVD alumina coatings on quartz substrates, which show no RI difference.

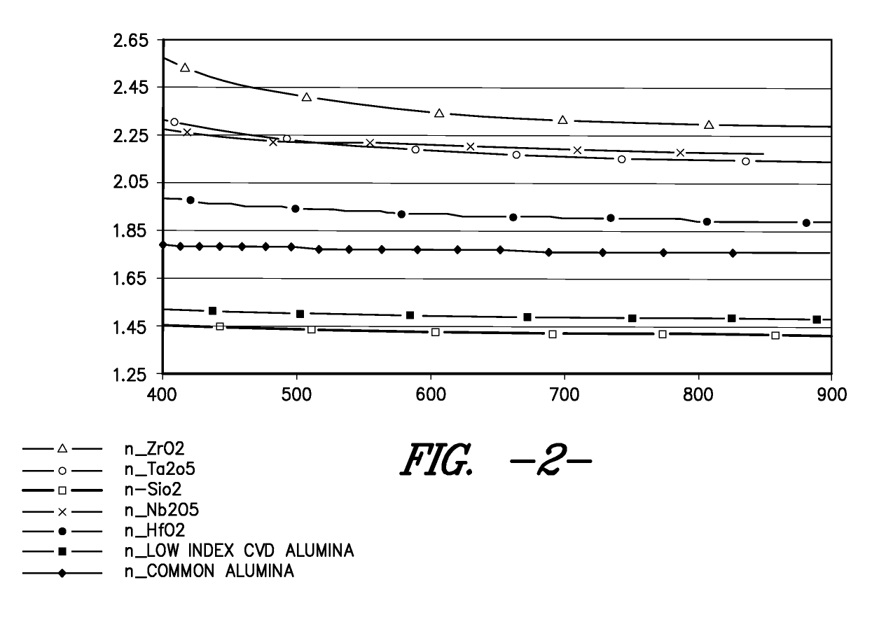

FIG. 2 shows the refraction index of various films across a wavelength spectrum from 400 nm to 900 nm. As shown, the optical alumina deposited via a CVD process from di-isopropoxy-acac-aluminum (available under CAS number 14782-75-3) at a temperature of about 600° C. and a pressure of about 10 torr and annealed at 800° C. has a refractive index that is significantly lower than a layer of common alumina. Thus, the optical alumina film can be utilized as a low refractive index layer in a multilayer stack.

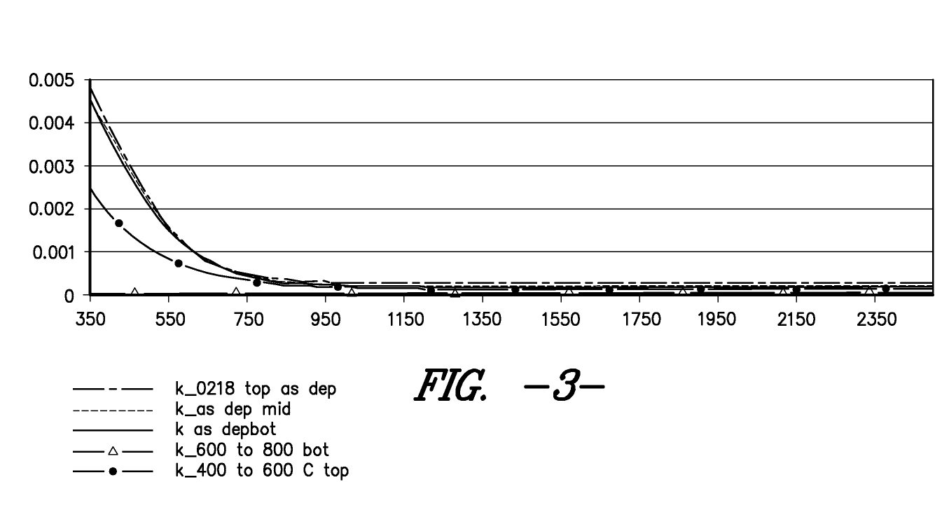

FIG. 3 shows the absorption of the optical alumina film layer as deposited, after annealing at 400° C. to 600° C., and after annealing at 600° C. to 800° C. As shown, the optical alumina layer had very low absorption in the visible spectrum as deposited, which became even smaller after annealing at 400° C. to 600° C. After annealing at 600° C. to 800° C., the absorption was substantially zero across the visible spectrum.

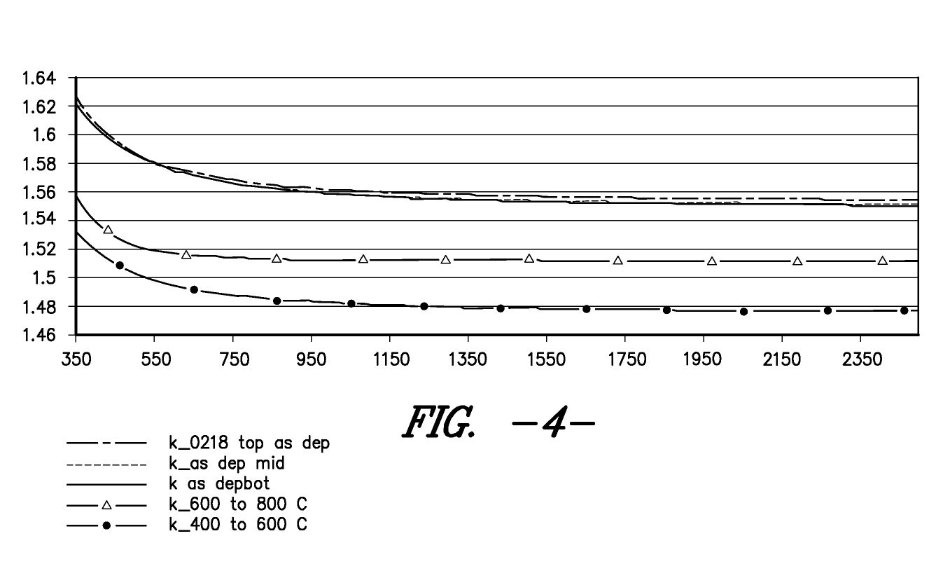

As deposited, the optical alumina film is already a low index film, because in most visible spectrum, its n<1.6. However, after annealing, n became even lower as shown in FIG. 4, and very close to silica, which makes the film an excellent low index film material because the larger the index contrast of H to L, the higher the film efficiency.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. An optical interference multilayer coating, comprising:
a plurality of alternating first layers and second layers,
said first layers having a refractive index that is about 1.38 to about 1.55 at 550 nm, and
said second layers having a higher refractive index than the first layers, wherein said first layers comprise alumina.

2. The optical interference multilayer coating according to claim 1, wherein said first layers are chemical vapor deposited.

3. The optical interference multilayer coating according to claim 2, wherein the first layers are formed from an alumina precursor comprising di-isopropoxy-acac-aluminum; trimethylaluminum; aluminum-di-acetoacetic ester chelate; Al₂(C₅H₇O₂)₃; aluminum tri-isopropoxide, a mixture of SiCl₄, AlCl₃, CO₂, and H₂; aluminum alkoxides; or mixtures thereof.

4. The optical interference multilayer coating according to claim 1, wherein said first layers have a refractive index from about 1.45 to about 1.55 at 550 um.

5. The optical interference multilayer coating according to claim 1, wherein said second layers have a refractive index from about 1.7 to about 2.8 at 550 nm.

6. The optical interference multilayer coating according to claim 1, wherein said coating has a geometrical thickness from about 0.001 to about 25 microns.

7. The optical interference multilayer coating according to claim 6, wherein said coating has a geometrical thickness of from about 1 to about 15 microns.

8. The optical interference multilayer coating according to claim 1, wherein said coating has a total number of layers of from 4 to 250.

9. The optical interference multilayer coating according to claim 1, wherein the alumina has a refractive index from about 1.38 to about 1.55 at 55 nm.

10. A lamp comprising:
a light source; and
a light-transmissive envelope having a surface, wherein said envelope at least partially enclosing said light source; wherein at least a portion of the surface of the light-transmissive envelope is provided with an optical interference multilayer coating comprising a plurality of alternating first layers and second layers, said first layers having a refractive index that is about 1.38 to about 1.55 at 550 nm, and said second layers having a higher refractive index than the first layers, wherein said first layers comprise alumina.

11. The lamp according to claim 10, wherein said first layers are chemical vapor deposited.

12. The lamp according to claim 10, wherein said first layers have a refractive index from about 1.45 to about 1.55 at 550 nm.

13. The lamp according to claim 10, wherein said second layers have a refractive index from about 1.7 to about 2.8 at 550 nm.

14. The lamp according to claim 10, wherein said coating has a geometrical thickness of from about 1 to about 15 microns.

15. The lamp according to claim 10, wherein said coating has a total number of layers of from 4 to 250.

16. The lamp according to claim 10, further comprising at least one electric element arranged in the envelope and connected to current supply conductors extending into the envelope.

17. The lamp according to claim 10, wherein the light source comprises filament or electric arc or combinations thereof.

18. The lamp according to claim 10, wherein the envelope encloses a fill gas comprising a halogen-containing gas.

19. A method of forming an optical interference multilayer coating, comprising:
forming a first layer on a substrate via chemical vapor deposition from an alumina precursor;
forming a second layer on the first layer; and
annealing the first and second layers such that the first layer has a refractive index that is about 1.38 to about 1.55 at 550 nm, and the second layer has a higher refractive index than the first layer.

20. The method according to claim 19, wherein the alumina precursor comprises di-isopropoxy-acac-aluminum; trimethylaluminum; aluminum-di-acetoacetic ester chelate; Al₂(C₅H₇O₂)₃; aluminum tri-isopropoxide, a mixture of SiCl₄, AlCl₃, CO₂, and H₂; aluminum alkoxides; or mixtures thereof.
